(19) United States
(12) Patent Application Publication
(10) Pub. No.: US 2011/0007344 A1
(43) Pub. Date: Jan. 13, 2011

(54) Multi-Bit Compression/Decompression Mechanism

(76) Inventors: John Charles Wilson, Longmont, CO (US); John Thomas Varga, Longmont, CO (US)

Correspondence Address: InfoPrint Solutions/ Blakely, 1279 Oakmead Parkway, Sunnyvale, CA, 94085-4040, US

(21) Appl. No.: 12/499,912

(22) Filed: Jul. 9, 2009

(51) Int. Cl. G06F 15/00

(52) U.S. Cl. 358/1.15

(57) ABSTRACT

A method is disclosed. The method includes receiving a print job, rasterizing the print job to produce rasterized data having a multi bit per pel print format, compressing the rasterized data into compressed data having a data section and a control section including compression control bits corresponding to each data value in the data section and transmitting the compressed data.

### FIELD OF THE INVENTION

The invention relates to the field of printing systems, and in particular, to reducing print data transmitted within a printing system.

### BACKGROUND

Printers are common peripheral devices attached to computers. A printer allows a computer user to make a hard copy of documents that are created in a variety of applications and programs on a computer. To function properly, a channel of communication is established (e.g., via a network connection) between the printer and the computer to enable the printer to receive commands and information from the host computer.

Once a connection is established between a workstation and the printer, printing software is implemented at a print server to manage a print job from order entry and management through the complete printing process. As data is transmitted from the workstation it is rasterized at a processor so that image data is converted from a vector graphics format (e.g., shapes) into a raster image (e.g., picture elements (pels)). After the data is rasterized it may be temporarily stored prior to being printed.

The amount of rasterized data transmitted from the processor is typically large. Thus, the processor typically implements a compression mechanism to compress, while the printer implements a decompression mechanism to decompress, the data prior to printing. Most current printers have the ability to print with one bit per pel data. Accordingly, a one bit per pel compression scheme is implemented to compress white pels. However, new printer models enable printing with multi bit per pel data.

Therefore, a multi bit per pel compression mechanism is desired.

### SUMMARY

In one embodiment, a method is disclosed. The method includes receiving a print job, rasterizing the print job to produce rasterized data having a multi bit per pel print format, compressing the rasterized data into compressed data having a data section and a control section including compression control bits corresponding to each data value in the data section.

Another embodiment discloses a print system including a print server to receive a print job and a printer. The print server includes a rasterizer to produce rasterized data having a multi bit per pel print format and a compression module to compress the rasterized data into compressed data having a data section and a control section including compression control bits corresponding to each data value in the data section. The printer includes a machine interface card (MIC) to receive the compressed data and a decompression module to decompress the compressed data into the rasterized data.

A further embodiment discloses an article of manufacture comprising a machine-readable medium including data that, when accessed by a machine, cause the machine to perform operations comprising receiving a print job, rasterizing the print job to produce rasterized data having a multi bit per pel print format, compressing the rasterized data into compressed data having a data section and a control section including compression control bits corresponding to each data value in the data section.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates one embodiment of a compression/decompression data format;

FIG. 3 illustrates another embodiment of a compression/decompression format;

FIG. 4 illustrates yet another embodiment of a compression/decompression format;

FIG. 5 illustrates still another embodiment of a compression/decompression format; and

FIG. 6 illustrates one embodiment of a computer system.

### DETAILED DESCRIPTION

A multi bit per pet compression/decompression mechanism is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

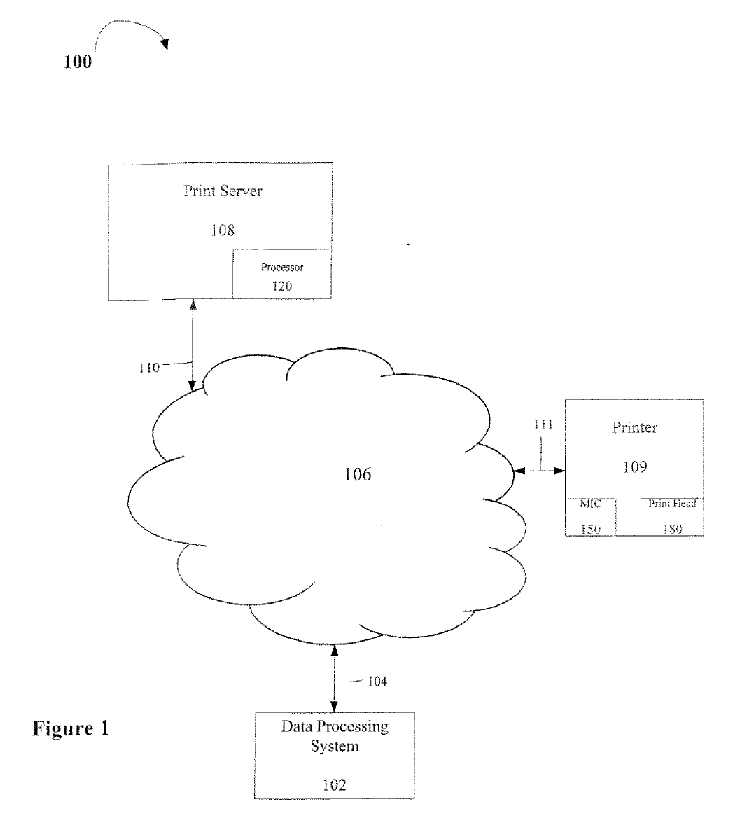

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In a further embodiment, data processing system 102 includes and employs the Windows operating system or a similar operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to a printer 109 for printing, which is coupled to network 106 via communications link 111.

In one embodiment, the operating system on data processing system 102 allows a user to submit requests for service requests to printer 109 via print server 108 over network 106. In a further embodiment, print server 108 includes a print queue for print jobs requested by remote data processing systems.

Although described as separate entities, other embodiments may include print server 108 being incorporated into printer 109. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of document data received from data processing system 102 at printer 109. Further, print server 108 includes a processor 120 that rasterizes document data received from data processing system 102 into a raster image having a multitude of pels.

Once the image is rasterized, the raster image is transmitted to printer 109, where the data is stored at machine interface card (MIC) 150 before being printed at one or more print heads 180. According to one embodiment, printer 109 may operate in either a one bit or multi bit per pel data print mode. However, in order to reduce the amount of data transferred between processor 120 and MIC 150, processor 120 also compresses the raster image prior to the transfer.

Whenever printer 109 is operating in the one bit per pet print mode, printer 109 implements a one bit per pet compression scheme in order to compress white pels. In the one bit per pet compression scheme, scan line data is broken into 32-bit length sections. Thirty-two of these sections are bundled together with an additional 32-bit header section, which results in 33 sections of 32 bits each. Thirty-two sections have data and one section has compression control information.

The compression control section has one control bit for each of the other thirty-two data sections. Bit 1 controls compression of data section 1, bit 2 controls compression of data section 2, and so on. If the control bit=0, this indicates that all 32 data bits in that section are zero or white pels. If the control bit=1, this indicates that at least one data bit is not zero and that future action is required.

During the compression process, sections of 32 data bits are examined for all zero data. If all are zero the control bit is set=0 and the data is eliminated and not transmitted to MIC 150. If the data is not all zeros, the control bit is set=1 and all 32 data bits are sent to MIC 150. In this manner, much of the zero (white) pets are compressed (removed) from the data transmitted to MIC 150. During the decompression process at printer 109, MIC 150 examines the control section and adds back 32 white pets each time the control=0 is encountered.

Whenever printer 109 is operating in the multi bit per pet print mode, printer 109 implements a multi bit per pet compression scheme in order to compress white pets. The multi bit per pet compression scheme is similar to the one bit process. However, instead of looking at the 1 bit that represents 1 pel, the process would look at multiple bits (e.g., 2, 4, etc.) that represent one pel.

For instance, in a two bit embodiment each data pet can have one of four values: 00=White; 01=Gray 1; 10=Gray 2; and 11=Black. This embodiment also has two bit control words. Thus, if all values in a data section are equal to zero, the control bits are set to 00 and the data bits are eliminated as discussed above with regards to the current one bit process. Similarly, if all values in a data section are equal to 10, the control bits are set to 10 and the bits are eliminated. The same process occurs for 01. For all other combinations of data an 11 is inserted into the header and all of the data is transmitted.

In another embodiment, the two bit control word headers are used to remove white and at least two patterns other than the Gray 1 and Gray 2 described above. In such an embodiment, testing may occur prior to system operation to determine which patterns occur most frequently. In one embodiment, the 01 and 10 control bits are implemented to remove Light Gray (e.g., mostly white) and Dark Gray (e.g., mostly black) patterns, respectively, while White continues to equal 00.

For Near White most of the print is white (data=00) with some near-white (data=01) such that the first bit of the control bit pairs is 0 (e.g., 00 01 01 00 00 00 01 01 . . . ). Similarly, for Near Black most of the print is black (data=11) with some near-black (data=10) such that the first bit of the control bit pairs is 1 (e.g., 10 11 11 10 10 11 10 10 . . . ). Alternatively, where control bits=00 indicate 32 pels are 00 throughout and 01 may indicate that first bits are 0's, while 10 indicates that the bits are mixed. Control bits=11 still indicate that the data does not match any pattern and should not be removed. Thus, If the first bits are selected as constant, then, only the second bit in the pairs need to be transmitted.

Control bits are subsequently assigned to those patterns to make the compression most efficient. In yet a further embodiment, additional header bits may be added to enable detection of other common patterns. For example, four control bit headers may be implemented to remove the 15 most occurring patterns. In still a further embodiment, control bits may be defined as either patterns or operations.

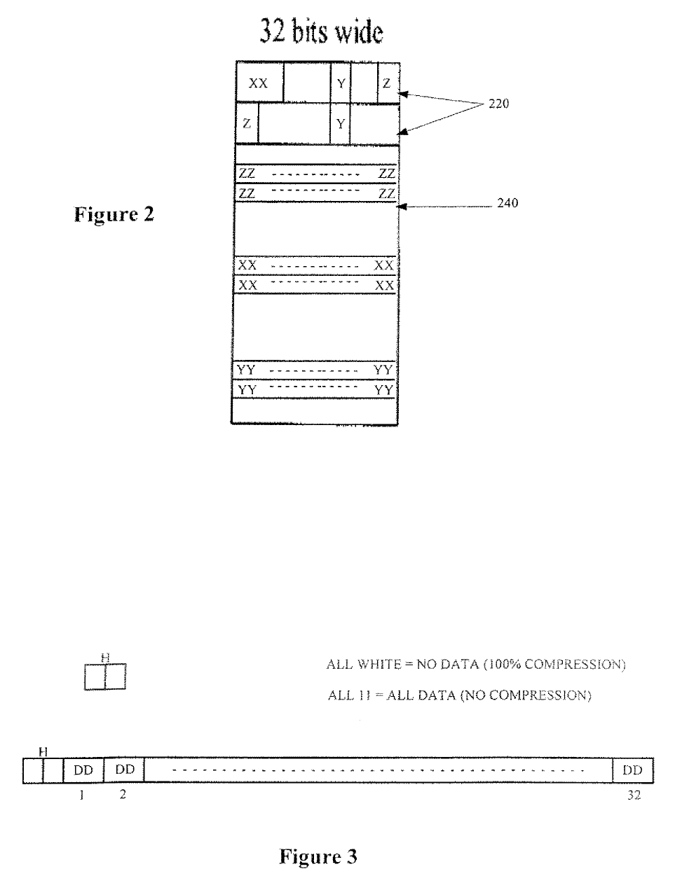

FIG. 2 illustrates one embodiment of a multi bit (two bits in this case) control word compression/decompression format that is applied to a 1200×2 dpi data system having a 32 bit bus, where each pel is represented by two data bits. In such an embodiment, two 32 bit wide headers 220 are implemented to compress 64 32 bit data words 240, where each 2 bit header pair represents two-32 bit data words (e.g., 1 header pair: 1 pair of 32 bit data words). In this embodiment, the compression is implemented with a two bit control word compression scheme to remove strings of 32 white (00) pels, plus strings of 32 (01) or (10) pels. The XXs, YYs, and ZZs in FIG. 2 show three of the many ways that header and data bits could be configured.

FIG. 3 illustrates one embodiment of the header to data ratio for the compression data format discussed in FIG. 2. As shown in FIG. 3, there are two 1-by-32 bit headers and two sections of 32-by-32 bit data. Once the data is compressed, the resulting output will consist of two 32 bit header words followed by zero to sixty-four 32 bit data words. There are zero if all data matched and was removed and 64 if no data matched. Most output is a result of some matching and will be somewhere between 0 and 64.

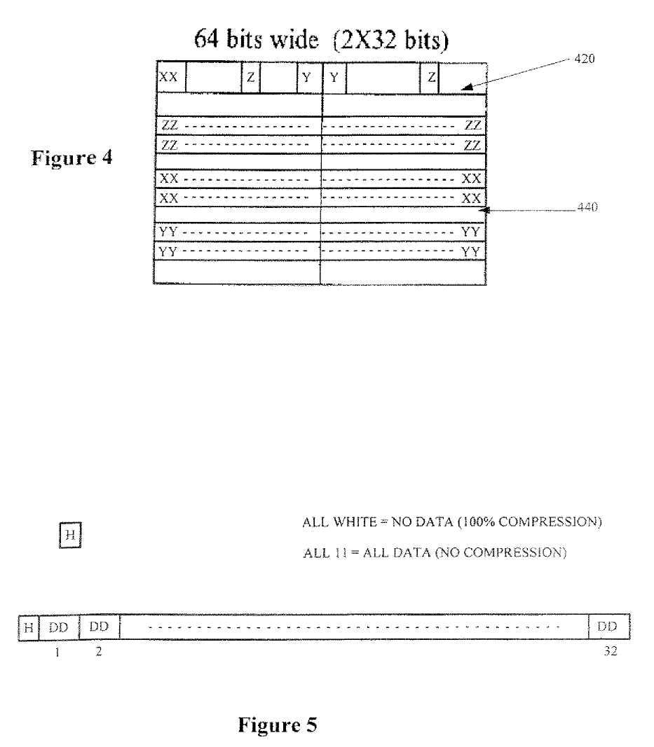

FIG. 4 illustrates one embodiment of a multi bit (two in this case) control word compression/decompression format that is applied to a 1200×2 dpi data system having a 64 bit bus. In this embodiment, one 64 bit wide header 420 is implemented to compress sixty-four 64 bit data words 440, where each 2 bit header pair represents two 64 bit data words (e.g. 1 header pair: 1 pair of 64 bit data words).

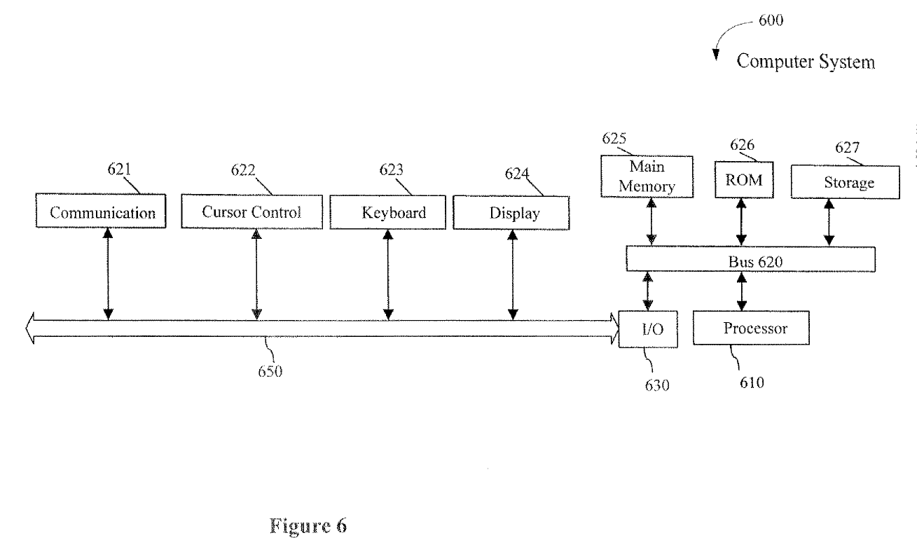

As shown in FIG. 5, there is one 1-by-64 bit header and zero to 64 sections of 2-by-64 bit data. There are zero if all data matched and was removed, and 64 if no data matched. Most output is a result of some matching and will be somewhere between 0 and 64. The XXs, YYs and ZZs in the figure show three of the many ways that header and data bits could be configured. FIGS. 2-5 show that multi bit compression can be implemented on 32 or 64 bit wide bus systems but it is not limited to these two. Therefore, multi bit compression can be applied to any bus width and any resolution.

According to one embodiment, printer 109 may support printing either one-bit data or multi-bit data on the same page. For example, text may be printed with one-bit, while images are printed with multi-bit. In such an embodiment, the data received at MIC 150 includes information indicating how the data should be processed (e.g., one or multi).

One embodiment of such control is that each set of pel data includes one additional bit. If the bit is 0 one-bit decompression is used and if the bit is 1 multi-bit decompression is used. To reduce the overhead associated with this scheme, the additional bit is bundled with the compression/decompression scheme so that, for instance, a 34th section is added to indicate if the information in the 32 data section is one-bit or multi-bit. This scheme reduces the overhead and yet only limits the boundaries of one-bit or multi-bit to every 32 pels or 32×n pels transmitted, where n=the number of bits per pel.

FIG. 6 illustrates a computer system 600 on which data processing system 102 and/or server 108 may be implemented. Computer system 600 includes a system bus 620 for communicating information, and a processor 610 coupled to bus 620 for processing information.

Computer system 600 further comprises a random access memory (RAM) or other dynamic storage device 625 (referred to herein as main memory), coupled to bus 620 for storing information and instructions to be executed by processor 610. Main memory 625 also may be used for storing temporary variables or other intermediate information during execution of instructions by processor 610. Computer system 600 also may include a read only memory (ROM) and or other static storage device 626 coupled to bus 620 for storing static information and instructions used by processor 610.

A data storage device 625 such as a magnetic disk or optical disc and its corresponding drive may also be coupled to computer system 600 for storing information and instructions. Computer system 600 can also be coupled to a second I/O bus 650 via an I/O interface 630. A plurality of I/O devices may be coupled to I/O bus 650, including a display device 624, an input device (e.g., an alphanumeric input device 623 and or a cursor control device 622). The communication device 621 is for accessing other computers (servers or clients). The communication device 621 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
receiving a print job;
rasterizing the print job to produce rasterized data having a multi bit per pel print format;
compressing the rasterized data into compressed data having a data section and a control section including compression control bits corresponding to each data value in the data section; and
transmitting the compressed data.

2. The method of claim 1 further comprising decompressing the compressed data into the rasterized data.

3. The method of claim 1 wherein compressing the rasterized data comprises assigning a set of control values to each set of control bits to fully describe a set of data values.

4. The method of claim 3 where a control value is reserved to represent an arbitrary data value.

5. The method of claim 3 where a control bit value represents an operation on a previous data value.

6. The method of claim 3 further comprising removing the data value in each data section if the corresponding control value is assigned as a specific data value.

7. The method of claim 4 further comprising transmitting the data value with the compressed data if a control value is assigned to the value representing an arbitrary data value.

8. The method of claim 3 wherein decompressing the compressed data comprises inserting data having a specific value into a section if a set of control bits has the corresponding control value.

9. The method of claim 4 wherein passing data having an arbitrary value into a data section if a set of control bits has the arbitrary control value.

10. The method of claim 1 further comprising determining if the print job is to be printed in the multi bit per pel print format or a one bit per pel print format.

11. The method of claim 10 further comprising:
rasterizing the print job to produce rasterized data having a one bit per pel print format if it is determined that the print job is to be printed in the one bit per pel print format; and
compressing the rasterized data into compressed data having a data section and a control section including one compression control bit corresponding to each of the data values and transmitting the compressed data.

12. A print system comprising:
a print server to receive a print job having:
a rasterizer to produce rasterized data having a multi bit per pel print format; and
a compression module to compress the rasterized data into compressed data having a data section and a control section including compression control bits corresponding to each data value in the data section; and
a printer having:
a machine interface card (MIC) to receive the compressed data; and
a decompression module to decompress the compressed data into the rasterized data.

13. The print system of claim 12 wherein the compression module compresses the rasterized data by assigning a set of control values to each set of control bits to fully describe a set of data values.

14. The print system of claim 13 where a control bit value represents an operation on a previous data value.

15. The print system of claim 13 herein the compression module removes the data value in each data section if the corresponding control value is assigned as a specific data value.

16. The print system of claim 13 wherein the decompression module decompresses the compressed data by inserting data having a specific value into a section if a set of control bits has the corresponding control value.

17. An article of manufacture comprising a machine-readable medium including data that, when accessed by a machine, cause the machine to perform operations comprising:
receiving a print job;
rasterizing the print job to produce rasterized data having a multi bit per pel print format;
compressing the rasterized data into compressed data having a data section and a control section including compression control bits corresponding to each data value in the data section; and
transmitting the compressed data.

18. The article of manufacture of claim 17, wherein the machine-accessible medium include data that cause the machine to perform further operations comprising decompressing the compressed data into the rasterized data.

19. The article of manufacture of claim 17 wherein the machine-accessible medium includes data that causes the machine to perform further operations comprising determining if the print job is to be printed in the multi bit per pel print format or a one bit per pel print format

20. The article of manufacture of claim 16, wherein the machine-accessible medium includes data that causes the machine to perform further operations comprising:
rasterizing the print job to produce rasterized data having a one bit per pel print format if it is determined that the print job is to be printed in the one bit per pel print format; and
compressing the rasterized data into compressed data having a data section and a control section including one compression control bit corresponding to each of the data values and transmitting the compressed data.
